(19) United States
(12) Patent Application Publication
(10) Pub. No.: US 2012/0235311 A1
(43) Pub. Date: Sep. 20, 2012

(54) Vapor blending system

(76) Inventor: Jesse Foster, Alexandria, LA (US)

(21) Appl. No.: 13/135,050

(22) Filed: Jun. 24, 2011

Related U.S. Application Data
(60) Provisional application No. 61/465,191, filed on Mar. 16, 2011.

(51) Int. Cl. B01F 3/04

(52) U.S. Cl. 261/121.1; 261/22; 261/122.1; 261/124

(57) ABSTRACT

The vapor blending system is a mechanical system that can create a homogenous vapor blend that is combustible and can be used as a supplemental fuel source for internal combustion engines. The system can be easily retro-fitted on vehicles (cars, trucks, buses, trains, etc.) to produce the vapor on demand. The basic objective of this invention is to create a viable supplement fuel that reduces the amount of carbon emission into the atmosphere when used as a fossil fuel supplement.

### CROSS-REFERENCE TO RELATED APPLICATION

This application claims the benefit of Provisional Application US No. 61/465,191.

### FEDERALLY SPONSORED RESEARCH

Not Applicable

### SEQUENCE LISTING OR PROGRAM

Not Applicable

### INCORPORATION-BY-REFERENCE OF MATERIAL SUBMITTED ON A COMPACT DISC

Not Applicable

### BACKGROUND OF THE INVENTION

1) Field of the Invention

The present invention relates to an apparatus designed to create a homogenous vapor blend by dispersing gases—air, hydrogen, and propane—that are drawn into closed chambers by a vacuum. The first chamber is partially filled with water and gasoline. The vapor blend is produced from the turbulence in the first chamber and is then transferred to a second chamber by pressure to be dispersed into additional gasoline. This activity in the second chamber increases the volume and the concentration of the homogenous vapor.

The present invention makes use of several gases dispersed in liquid water, and gasoline/diesel to create a homogenous blend of vapor. The turbulent motion of the gases dispersed in water and gasoline causes additional molecules of the liquids to blend with the gases to create additional vapor.

Since the vapor blend is created at ambient temperature, it remains as a vapor and can be used as a supplemental fuel for internal combustion engines. The vapor blend produced by the vapor blending system is highly combustible and can be added directly to the air intake system of an internal combustion engine as a fuel additive or fuel supplement. A flashback arrester can be used inline leading to the air intake to the internal combustion engine to prevent explosions from inadvertently occurring.

The vapor blending system is designed to work equally as well with diesel engines. Diesel fuel may be used instead of gasoline in the vapor production process. Ethanol can also be substituted for water in the vapor blending process.

The vapor blend produced by the vapor blending system is controlled at a medium pressure going into the air intake system of an internal combustion engine. The blended vapor mass can triple the gas mileage of gasoline and reduces the requirement of fossil fuel as the primary fuel for internal combustion engines. The vapor mass produced by the vapor blending system obeys the laws of “partial pressure.”

P_{H}_{₂}^{O}+Pₐᵢᵣ+P_{gasoline}+P_{natural gas}+P_{H}_{₂}+P_{O}_{₂}=Total Pressure Example

The claimed invention allows the vapor mass to be produced as needed and when needed on board vehicles and requires no storage. The vapor blend becomes very economical when the hydrogen gas requirement is produced from the electrolysis of water on board vehicles.

A great advantage of using the blended vapor as a supplemental fuel for internal combustion engines is that the vapor mass greatly reduces the amount of carbon emission into the atmosphere during the combustion process.

The final vapor blend created in the second closed chamber is a homogenous vapor blend consisting of air, hydrogen, gas gasoline vapor and propane. The vapor blend created is highly combustible and can be used as a supplemental fuel source for internal combustion engines.

The vapor blending system can be retro-fitted on vehicles—cars, trucks, buses, suvs, and etc. The vapor can be generated on board vehicles, thus eliminating the need for vapor storage. The only energy requirement to make the system functional is a 12 volt D.C. current.

2) Description of Related Arts

Internal combustion engines are well-known in the prior art. It is generally understood that internal combustion engines are designed to utilize fossil fuel in its vapor state. The fossil fuels that are customarily utilized in the internal combustion engines is gasoline or diesel which exists in the liquid state and must be converted to vapor to be effective as a fuel.

The current practice requires gasoline or diesel fuel to be inefficiently introduced into the cylinder chambers of an internal combustion engine as a fine mist. Even though the ignition procedure allows most of the fossil fuel to vaporize, a large quantity of the fuel remains as a liquid, thus causing it to result in low energy conversion and engine “gum-up.”

Another practice well-known in the art is the use of fuel additives to increase the energy factor of the fuel source. It is well-known that there are several additives that can be added to gasoline or diesel to improve fossil fuel combustion. However, these additives are expensive and not cost effective for internal combustion engines. The present invention attempts to address these prior art shortcomings.

### SUMMARY OF INVENTION

The claimed invention is a system designed to disperse gases—air, hydrogen, and propane—into water or ethanol and gasoline to create a vapor blend from the molecules. The final product produced from the turbulent action of the gases and liquids is a homogenous vapor blend that is highly combustible. The vapor blend created by the vapor blending system can be used as a supplemental fuel for internal combustion engines. The vapor—when used as a supplemental fuel for internal combustion engines—reduces the carbon emission normally generated by internal combustion engines. The vapor blending system works equally as well when diesel fuel is substituted for gasoline in the vapor producing process. Also, ethanol alcohol can be substituted for water. The claimed invention is designed to be retro-fitted on vehicles to generate the vapor blend, thus eliminating the need for vapor storage.

### BRIEF DESCRIPTION OF DRAWINGS

FIG. 1 illustrates the construction of the gas dispersion tee.

FIG. 2 illustrates the arrangement of three gas dispersion tees attached to the screw cap of the first chamber.

FIG. 3 illustrates the physical arrangement of the dispersion tees within the first chamber.

FIG. 4 is a two-dimensional view of the second chamber.

FIG. 5 is a two-dimensional diagram of the vapor blending system.

FIG. 6 is a three-dimensional view of the first chamber.

FIG. 7 is a three-dimensional view of the second chamber.

### DRAWINGS

### Reference Numerals

1 Mini vacuum pump
2 Vacuum line exiting first chamber
3 Vapor line entering second chamber
4 Dispersion tee
5 Air inlet line
6 Hydrogen inlet line
7 Propane inlet line
8 Water zone

9 Gasoline zone
10 Blended vapor zone
11 Shut-off valve
12 First Chamber
13 Second Chamber
14 Re-fill line
16 Safety check valve
17 Blended vapor outlet line
18 Vent
19 Housing
20 Threaded cap
21 Threaded shell
22 Fine wire mesh
24 Metal caps
25 Metal shell
26 Dispersion tee inlet
27 Metal tube extension

### DETAILED DESCRIPTION OF THE INVENTION

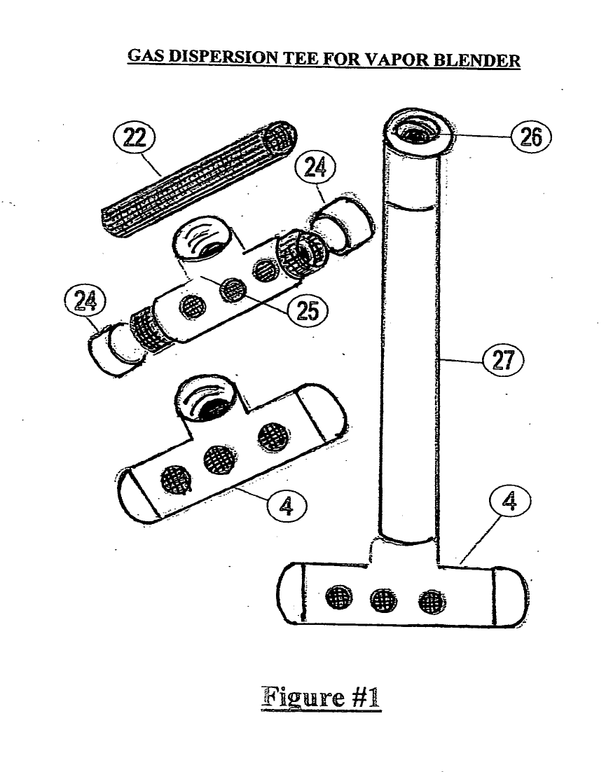

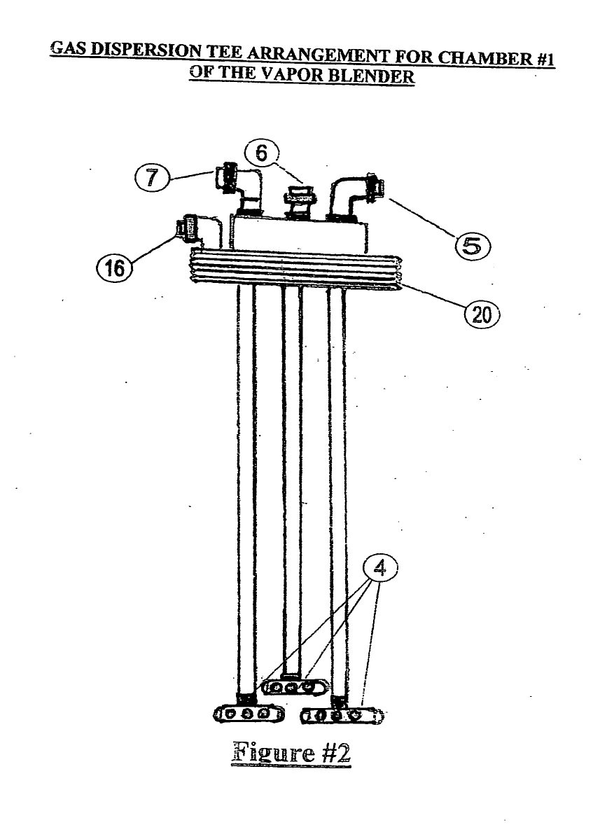

Referring now to FIGS. 1 and 2, the construction of the gas dispersion tee (4) commonly used in the first chamber (12) and the second chamber (13) is shown. The dispersion tee (4) consists of a fine mesh screen (22) enclosed in a metal shell (25) with caps (24) on both ends of the metal shell (25). The metal shell (25) is equipped with holes to disperse gases into the liquid zones (8), and (9) of the first chamber (12) and the second chamber (13). The dispersion tees (4) are attached to a metal tube extension (27) that extends to the outside of the first chamber (12) and are attached to the incoming air inlet line (5), hydrogen inlet line (6), and propane inlet line (7) via the dispersion tee inlet (26).

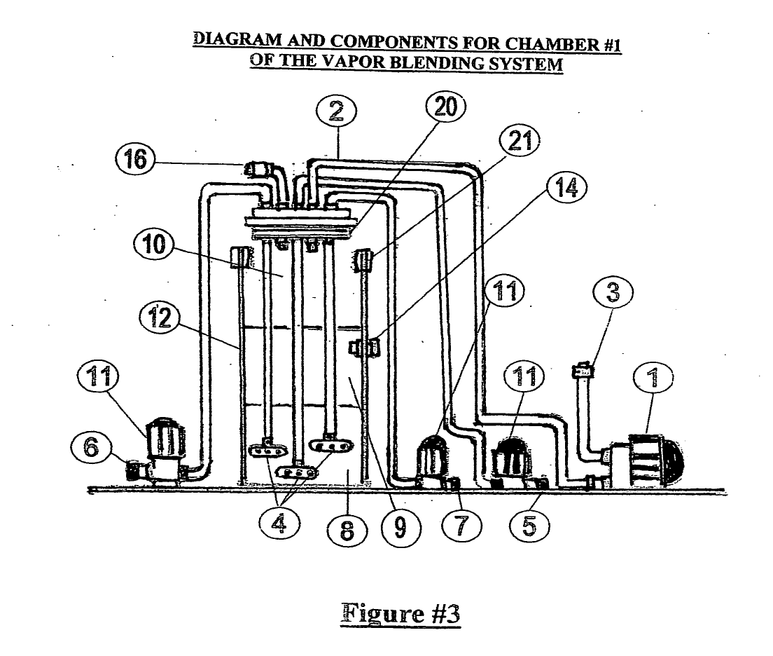

Referring now to FIGS. 2 and 3, the construction and arrangement of three gas dispersion tees (4) to be inserted in first chamber (12) of the vapor blending system is shown. The first chamber (12) and second chamber (13) are comprised of a suitable material such as aluminum and are formed into cylinders and further comprises a screw cap (20), which includes a safety valve (16) attached for controlling pressure in the blended vapor zone (10) of the first chamber (12).

Specifically referring now to FIG. 3, a detailed description of the first chamber (12) of the vapor blending system showing the physical arrangement of the dispersion tees (4) inserted in first chamber (12) is provided. As shown, the first chamber (12) contains liquid gasoline and water or ethanol and vacant space for vapor accumulation. As shown, one of the dispersion tees (4) is attached to the air inlet line (5), another dispersion tee (4) is attached to the hydrogen inlet line (6), and a third dispersion tee (4) is attached to the propane inlet line (7). The air inlet line (5), hydrogen inlet line (6), and propane inlet line (7) are each attached to shut off valves (11). All three dispersion tees (4) are fixed stationarily in the lower liquid zone (8) of the first chamber (12). When gases are suctioned into the first chamber (12) the dispersion tees (4) create a turbulent motion between the gases and the liquids forming a vapor blend with gaseous molecules and the molecules released from the volatile gasoline and water or ethanol. FIG. 3 also shows the safety valve (16) installed in the screw cap (20) to control the pressure inside the first chamber (12). As shown, the suction side of the vacuum pump (1) is attached to the vapor zone (10) of first chamber (12) via the vacuum line (2) to suction in the gases from the air inlet line (5), hydrogen inlet line (6), and propane inlet line (7).

The vapor produced in the first chamber (12) is transferred to the second chamber (13) by-way-of-the pressure side of the mini-vacuum/pressure pump (1) via the vapor line (3). The vapor blend is transferred to the second chamber (13) at low pressure. Both chambers (12,13) are arranged such that a sufficient amount of space is available for vapor blending and for the introduction of additional matter. The claimed invention is designed for the mini-vacuum/pressure pump (1) to cooperate with both mixing chambers (12, 13).

The vapor blend that is transferred from the first chamber (12) passes through a dispersion tee (4) that is fixed stationarily in the gasoline zone (9) of the second chamber (13) to create additional vapor from gasoline molecules. The final vapor accumulated in the vapor zone (10) of the second chamber (13) is a homogenous mixture of combustible vapor that can be used as a supplemental fuel for internal combustion engines. The claimed invention further comprises a safety check valve (16) on the second chamber (13) to control the pressure at a low pressure in the vapor zone (10).

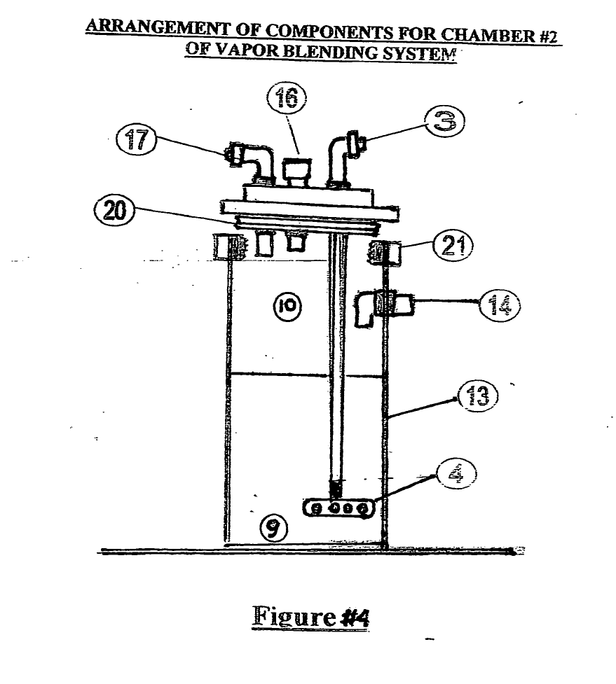

Referring now to FIG. 4, the second chamber (13) has a dispersion tee (4) connected to the vapor line (3) exiting the mini-vacuum pump (1) which transports the vapor leaving the first chamber (12) and introduces it to the gasoline zone (9) of the second chamber (13) by way of a dispersion tee (4) installed in second chamber (13). FIG. 4 further shows the screw cap (20) with a safety valve (16) to control the vapor in the vapor zone (10) of the second chamber (13). The pressurized vapor produced in the vapor zone (10) of the second chamber (13) can exit the second chamber (13) through an exit line (17). FIGS. 3 and 4 show that both chambers (12,13) have threaded openings (21) for which the screw caps (20) fit to form a closed chamber.

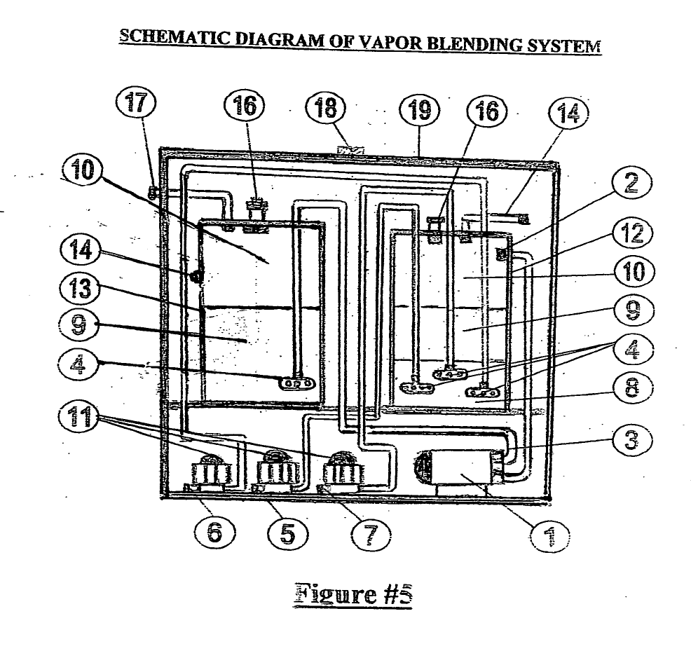

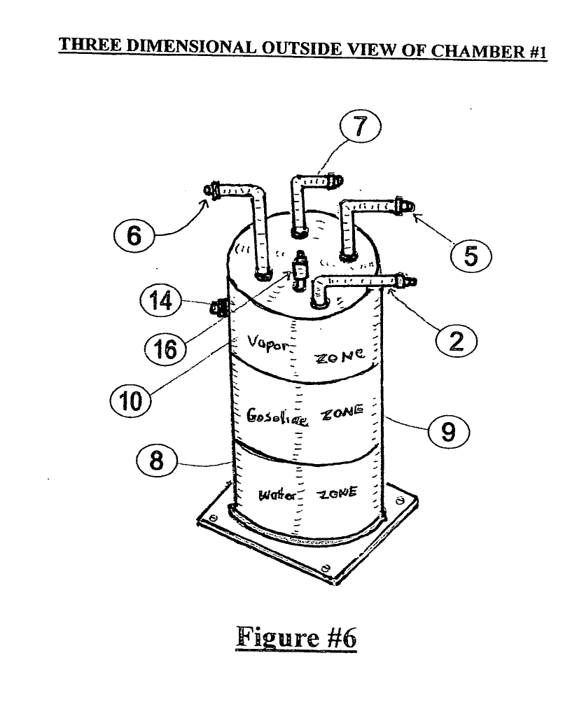

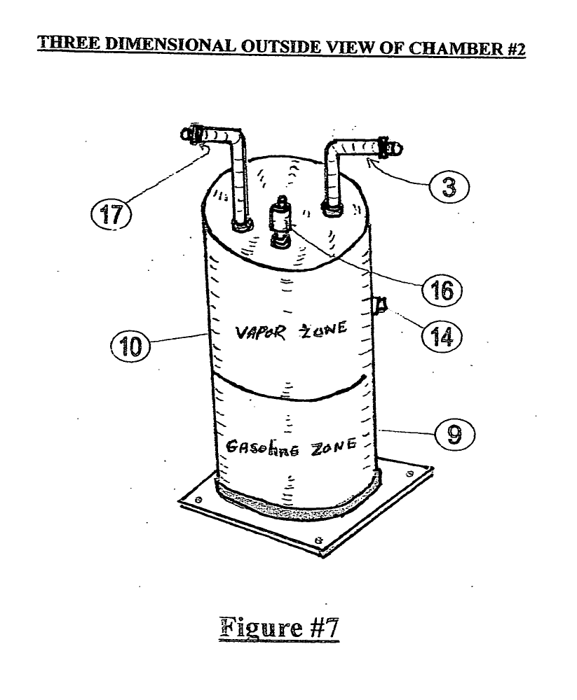

FIGS. 5 and 7 show that the first chamber (12) and second chamber (13) are equipped with a refill line (14) for adding additional liquids and gasoline and that the system is arranged within a housing (19) that is equipped with a vent (18). FIG. 6 illustrates the air inlet line (5), hydrogen inlet line (6), and propane inlet line (7) into the first chamber (12). A safety valve (16) is installed in the screw cap (20) to control the pressure inside the vapor zone (10). FIG. 7 illustrates the vapor inlet line (3) entering the second chamber (12) and the vapor outlet line (17) exiting the second chamber (13).

In practice, the first chamber (12) is partially filled with water (⅓ of volume), gasoline (⅓ of volume), and the remaining ⅓ volume space remains vacant for the physical mixing vapors that the system is designed to produce. In certain cases, ethanol can be substituted for water.

When the vacuum pump (1) is activated, it reduces the pressure in the vapor zone (10) of the first chamber (12), thereby causing gases, water and gasoline to mix. When the shut off valves (11) are activated, the gases are suctioned into the first chamber (12) through dispersion tees (4).

The pressurized vapor blend leaving the first chamber (12) is attached to the second mixing chamber (13). The pressurized vapor leaving the first chamber (12) passes through a dispersion tee (4) extending into the gasoline zone (9) of the second chamber (13). The homogenous vapor blend exiting is combustible and can be added to the air intake line (17) of an internal combustion engine as a supplemental fuel. Both chambers (12,13) are designed to operate at a low pressure

1. A vapor blending device comprising:
a) a primary blending chamber described as chamber #1, wherein, chamber serves as a dispersion vessel that homogenously mix vapors;
b) dispersion tees attached to gas inlet lines leading to chamber #1 for dispersing incoming gases in water and gasoline;
c) a vacuum source produced by a mini-vacuum/pressure pump, wherein, the vacuum side of the pump initiate the mixing of liquids and gases;
d) a pressure source produced by the pressure side of the mini-vacuum/pressure which pumps pressurized vapor to a second chamber;
e) shut off valve for controlling the flow of gases entering the chamber #1
f) a safety check valve for preventing vapor from inadvertently building up above 10 psi in chamber #1.

2. A vapor blending device described in claim 1, further comprising:
a) a secondary blending chamber described as chamber #2 wherein, this chamber serves as a receiving vessel for pressurized vapors leaving chamber #1 and for additional formation of vapor;
b) a dispersion tee for mixing incoming vapor with liquid gasoline
c) a shut off valve for regulating the flow of gas entering the secondary blending chamber #2;
d) a safety check valve for preventing the vapor pressure from inadvertently building up above 10 psi in chamber #2

3. A vapor blending system comprising:
a. A first chamber having a water zone, gasoline zone, and vapor zone,
b. An air inlet line that enters said first chamber and is attached to a gas dispersion tee arranged within the water zone of said first chamber,
d. A hydrogen inlet line that enters said first chamber and is attached to a gas dispersion tee arranged within the water zone of said first chamber,
e. A second chamber having a gasoline zone and vapor zone,
f. A vapor line that exits said first chamber and enters said second chamber and is attached to a gas dispersion tee arranged within the gasoline zone of said second chamber,
g. A vapor blend line that exits said second chamber,
h. Safety check valves arranged on said first chamber and said second chamber,
i. A refill line arranged on said first chamber and said second chamber,
j. Shut-off valves attached to said air inlet line, and said hydrogen inlet line, and
k. A vacuum source that cooperates with said first chamber and said second chamber.

4. (canceled)

5. (canceled)

6. A method of creating a vapor blend comprising:
a) Providing a first chamber having a water zone, gasoline zone, and vapor zone,
b) Providing an air inlet line that enters said first chamber and is attached to a gas dispersion tee arranged within the water zone of said first chamber,
c) Providing a hydrogen inlet line that enters said first chamber and is attached to a gas dispersion tee arranged within the water zone of said first chamber,
e) Providing a second chamber having a gasoline zone and a vapor zone,
f) Providing a vapor line that exits said first chamber and enters said second chamber and is attached to a dispersion tee arranged within the gasoline zone of said second chamber,
g) Providing a vapor blend line that exits said second chamber,
h) Providing safety check valves arranged on said first chamber and said second chamber,
i) Providing a refill line arranged on said first chamber and said second chamber,
j) Providing shut-off valves attached to said air inlet line, and said hydrogen inlet line, and
k) Providing a vacuum source that cooperates with said first chamber and said second chamber whereby when activated said vacuum source suctions air from said air inlet line, and hydrogen from said hydrogen inlet line, into said first chamber via said gas dispersion tees arranged within the water zone of said first chamber causing bubbles thereby producing a vapor within said first chamber that exits said first chamber via said vapor line and enters said second chamber via said dispersion tee arranged within the gasoline zone of said second chamber, causing bubbles thereby producing a vapor within said second chamber that exits said second chamber via said vapor blend line.
